(19) United States
(12) Patent Application Publication
(10) Pub. No.: US 2012/0192046 A1
(43) Pub. Date: Jul. 26, 2012

(54) GENERATION OF A SOURCE COMPLEX DOCUMENT TO FACILITATE CONTENT ACCESS IN COMPLEX DOCUMENT CREATION

(76) Inventors: DAVID NEIL SLATTER, Bristol (GB); Darryl Greig, Fishpond (GB); Andrew Hunter, Bristol (GB)

(21) Appl. No.: 13/012,940

(22) Filed: Jan. 25, 2011

(51) Int. Cl. G06F 17/00

(52) U.S. Cl. 715/202

(57) ABSTRACT

A system to generate a source complex document can include memory for storing computer executable instructions and a processor for accessing the memory and executing the computer executable instructions. The computer executable instructions can include an interface to access selected content from a source of content. An ingest engine can populate the source complex document with the selected content from the source of content, attribute data being added to the selected content and stored with the selected content in the memory such that the selected content of the source complex document is dynamically linked via the attribute data in a format that is substantially identical to that of a target complex document.

### BACKGROUND

A user can acquire digital images, text and other content from various sources, such as over the internet, from files, from digital cameras and other types of digital media. A common exercise with such content is to create a new complex document based on the content they have already acquired. Existing tools for this task can be difficult for many users to implement because they may require in-depth knowledge of multiple mechanisms for retrieving and manipulating source content within their particular document creation tool. For instance, such existing solutions may require use of a variety of different editing tools and other mechanisms for retrieving, accessing and editing different types of content, which usually vary according to the source of the content.

As an example, to insert an image into most document creation tools may require either a File→Open operation, then a dialog box selection operation, followed by some kind of cut and paste depending on the application associated with the image type, or alternatively an Insert operation, then a dialog box selection. However, the same result may be achieved by the copy and paste operations built into the document creation tool when the required image already exists in a document compatible with the creation tool.

### BRIEF DESCRIPTION OF THE DRAWINGS

FIG. 1 depicts an example of a system for generating a source complex document.

FIG. 2 depicts another example of a system for generating a source complex document.

FIG. 3 depicts an example of a data structure that can be used for a source complex document.

FIG. 4 is a flow diagram depicting an example of a method for generating a source complex document.

FIG. 5 is a flow diagram depicting another example of a method for generating a source complex document.

### DETAILED DESCRIPTION

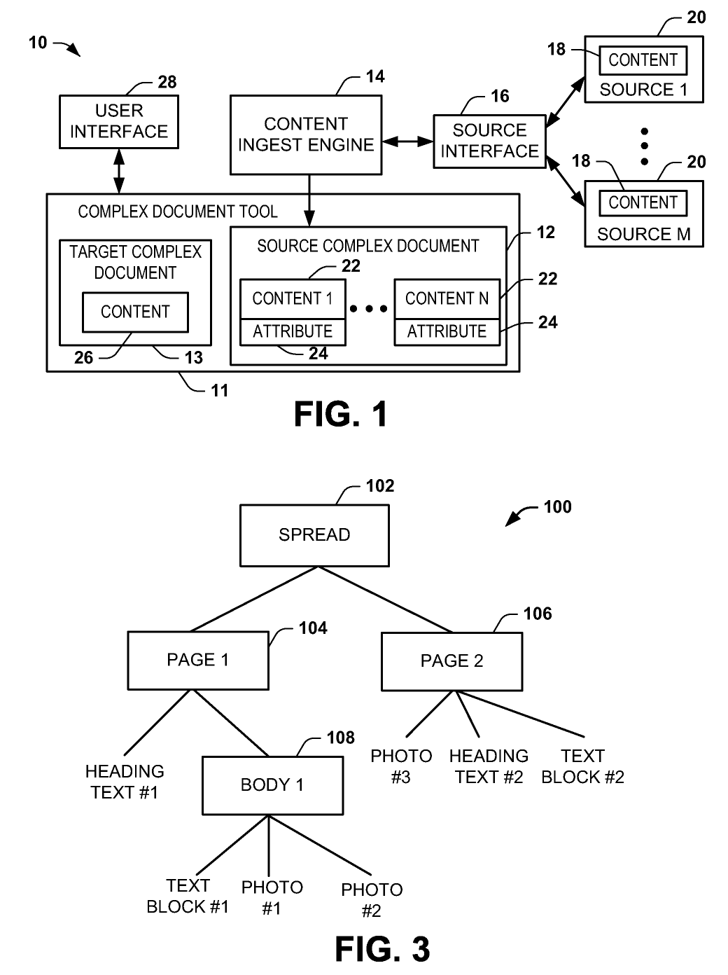

FIG. 1 depicts an example of a system 10 that can be utilized to generate a source complex document 12. The source complex document is generated to have a format entirely compatible with a complex document tool 11 being used to create or edit a target complex document 13. By providing source complex document 12 in this way, the system 10 can present the user with content (e.g., within the complex document tool), which may have been originally provided in different forms and from different sources, in a consistent interface format that is the same as the target complex document 13 being created.

As used herein, a complex document refers to a document that can contain multiple types of content and with higher level layout functionality imposed upon the content. For instance, a complex document contains a group of elements selected from the group comprising text elements (including headings, page numbers, figure indices etc) and graphical elements (including photos, vector graphics objects, line art, clip art, color gradients etc). The modifier “source” in the term “source complex document” is intended to indicate that the document is to be used as a source of content. As such, the source complex document can be write-protected upon its creation, such that any part or the entire document can be copied into a target complex document without causing changes to the source complex document. The user actions to copy content from the source to the target document are the same as those used to manipulate and edit content within the target complex document. The copied content can be manipulated and edited within the target complex document via the tool 11.

As used herein, the term “includes” means includes but not limited to, the term “including” means including but not limited to. The term “based on” means based at least in part on.

A complex document also includes a layout format that defines an arrangement of containers within the complex document into which other elements can be placed in the layout. A container can be a column, a block, a circle or other graphical shapes. Additionally, where the disclosure or claims recite “a,” “an,” “a first,” or “another” element, or the equivalent thereof, it should be interpreted to include one or more than one such element, neither requiring nor excluding two or more such elements.

The system 10 includes a content ingest engine 14. The content ingest engine 14 can be implemented as computer executable instructions that can be accessed from memory by a processor to generate the source complex document 12. The content ingest engine 14 employs an interface to access selected content 18 from a source of content 20. It is to be understood that there can be any number of one or more interfaces and any number of 1 through M sources of content 20, where M is a positive integer denoting the number of sources of content.

The interface 16 can also vary depending upon the source of content 20. For example, the source of content 20 can be a file stored in memory of a computer, which may be the same or different computer from that implementing the ingest engine 14 or the interface 16. The memory can be a fixed for removable type of memory (e.g., a hard disk drive, a flash drive, an optical disk or the like). In the example implementation where the source of content 20 is a file in memory, the interface can include hardware, machine readable instructions (including computer executable instructions) or a combination of hardware and machine readable instructions (including computer executable instructions) for accessing and retrieving the file from the memory.

In another example implementation the source of content 20 can be a website, such as served via a network. In such an example implementation, the interface can include hardware, computer executable instructions or a combination of hardware and computer executable instructions for accessing and retrieving the content 18 from the network. In another example implementation, the source of content 20 can also include a portable electronic device, such as a digital camera, a personal digital assistant (PDA), a smart cellular telephone, an E-book reader or the like. In such an example implementation, the interface can include hardware, computer executable instructions or a combination of hardware and computer executable instructions for accessing and retrieving the content 18 from the portable electronic device.

Each source of content 20 can include a variety of content that can vary in form and extent. As an example, the content 18 can include images, such as photographs or other graphical objects, text, and in combinations of different types of content. The content 18 can also include patterns, layouts and any other document features that can be ascertained and utilized within the source complex document 12.

The content ingest engine 14 is operative to populate the source complex document 12 with content elements 22 that are derived from the content 18 retrieved via the interface 16. The content ingest engine 14 thus can arrange each of the content elements in the source complex document browsers to allow a user to build a new complex document, namely a target complex document. There are various ways that content can be added to and removed from a target complex document. For example, an element or group of elements from the plurality of source complex document browsers can be placed over existing elements in the target complex document browser, which causes the existing elements to be replaced by the copied elements. The element or group of elements from the plurality of source complex document browsers can also be placed in open spaces in the target complex document browser, which causes the existing elements to be placed into the target complex document associated with the target complex document browser. Those skilled in the art will appreciate various other editing mechanisms and tools that can be utilized to utilize content from source complex documents.

The content ingest engine 14 also is programmed to add corresponding attribute data 24 to each content element 22. The attribute data 24 can include a layout mechanism that affords appropriate dynamic behavior to a given content element 22. For example, the attribute data includes an identification of element properties that can define restrictions and formatting requirements that enable desired dynamic behavior when a content element is copied or manipulated by an associated document service (e.g., by a document editor service). For instance, the source complex document 12 can be stored in memory of the system 10 and be made accessible to a service-based editing tool.

The attribute data can also be utilized to specify a type of content, such as whether the content is an image, a text block, designs, headings, or the like. The attribute data can also include data identifying the source 20 of the content element 22, an attribution to the author of such content, a cost (if known) for subsequent usage of the content. The attribute data can also be utilized to specify a hierarchy, restrictions and/or layout requirements associated with the content element 22, which can be utilized by the ingest engine in populating the content elements 22 in the source complex document 12.

The content ingest engine 14 further can employ an automated layout procedure to generate the source complex document 12 based upon the content retrieved from the sources 20, such that each of the content elements 22 are dynamically linked via the attribute data 24 according to the automated layout procedure. As an example, the automated layout procedure can employ rules and a layout format in which each respective content element is to be inserted based on its corresponding attribute data 24. The layout format can be fixed or adaptable, such as by modifying layout features and placement based on the attribute data of the respective content elements.

Once the source complex document 12 has been created from the content sources 20, then the content elements 22 with associated attributes 24 are accessible within the complex document tool 11. For example, a user can employ a corresponding user interface 28 for the complex document tool 11 to create or edit content 26 for the target complex document 13. That is, the user interface 28 can be programmed to implement native copy and edit functionality of the tool 11, without requiring any resort on the part of the user to the original content sources 20 or associated external applications.

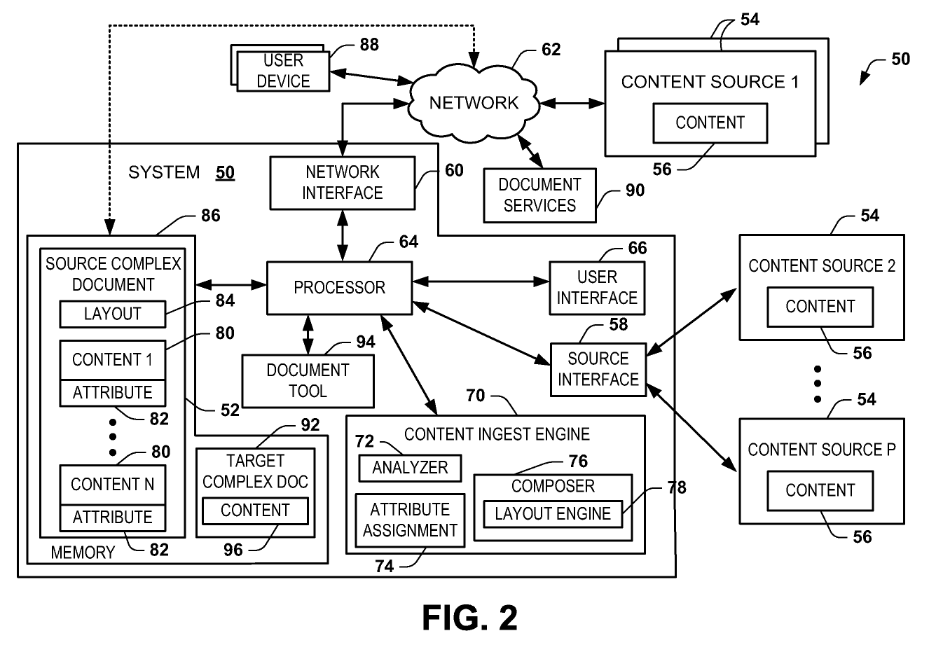

FIG. 2 depicts another example of a system 50 that can be utilized for generating a source complex document 52. The system 50 can access any number of content sources 54 that may contain content 56. Each of the content sources 54 can include a variety of content in different forms and types such as described herein.

In the example of FIG. 2, the system 50 employs a source interface 58 to access content source 2 through content source P, where P is a positive integer denoting the number of content sources that can be accessed by the system via the interface 58. The system may employ a different interface to access content from each source. As one example, the content source 54 can be storage media, such as a hard disc drive, a flash media device, or other device that may be coupled to the system 50 and accessible via the interface 58. The source interface 58 can include hardware, computer executable instructions or a combination of hardware and computer executable instructions configured for accessing and retrieving the content 56 from each content source 54.

As another example, the system 50 can access content sources 54 via a network interface 60. For example, content sources 54 can be coupled to the system 50 via a network 62, which can include a local area network or a wide area network, such as the internet or a cellular network, or a combination of different networks topologies. The network interface may also be implemented as a search engine that can access content on the network based on a search term. Content located by the search engine can be automatically accessed and retrieved for generating the source complex document 52.

The system 50 includes a processor 64 that can execute computer executable instructions for generating the source complex document 52. In the example of FIG. 2, the processor 64 can employ a user interface 66 to select content from any of the one or more content sources 54 that the system 50 may access. The user interface 66 can be utilized to identify a resource location for desired content that is to be ingested by the system 50 for use in generating the source complex document 52.

As an example the user interface 66 can be programmed to identify a file location on a storage media that can be accessed via the source interface and retrieved by the system 50. Additionally or alternatively, the user interface 66 can be implemented as a network browser that is capable of specifying a resource locator for a webpage (e.g., a uniform resource locator (URL)), or a file location (e.g., a resource location that is served via a file transfer protocol (FTP)), which are accessible via the network 62 by the network interface 60. Thus, the processor 64, in response to user instructions received via the user interface 66, can access and retrieve content 56 from any of the sources 54.

The processor 64 can also employ a content ingest engine 70 for generating the source complex document 52. The content ingest engine 70 thus is programmed with methods, functions and processes that can be executed by the processor 64. It will be understood that the components of the content ingest engine can reside locally a computer or be distributed across a network, such as the network 62. As one example, the content ingest engine can be implemented as part of document service in a cloud computing environment.

In the example of FIG. 2, the content ingest engine 70 includes an analyzer 72 that is programmed to analyze the selected content that is being ingested to identify content elements from the selected content as well as properties associated with such content. The content elements of the content 56 may be stored in a single document, a file or other form at the content source 54. As an example, the analyzer 72 can parse the content object 56 from a source and identify one or more distinct content elements that may be embedded therein. Such embedded content elements may include, for example, text blocks, images or the like. The analyzer 72 can also employ methods for converting content from one form to another, which conversion methods may be implemented locally within the system 50 or via calls to external processes (e.g., via the network 62). For example, the analyzer can convert various file formats to a predetermined set of standard file formats that are utilized for generating the source complex document 52. Alternatively, content elements can retain their original formats for use in generating the source complex document 52.

The analyzer 72 can also discern properties of each identified content element. The properties of a given content element can include a type or format of content (e.g., image type, text format or the like). The type of the content can be the same as the original content 56 being retrieved or it can be a different type based on a conversion process that is implemented by the analyzer 72. The properties can also include a class of content, such as an identification whether the content element is a heading, a box, a banner, a background or the like. Further details of a given class of content can also be determined for each content element, such as language and font for text elements as well as resolution and color depth for images.

In addition to properties of the content element, the analyzer 72 can also ascertain source-related information for the content being retrieved. As an example, the source-related information can include an identification of a resource location for the content source 54, an identification of the author of the content element, as well as any use restrictions and associated cost for the content. The properties can thus describe characteristics of the content elements, which can vary for each content element, and the source-related information for the respective content sources 54.

The content ingest engine 70 can also include an attribute assignment component 74. The attribute assignment component 74 can be programmed to assign attribute data to the selected content elements based on properties ascertained by the analyzer 72. For example, the attribute data can be implemented as metadata that specifies the type of the content (e.g., an image, the type of image). The attribute data that is added to each content element can be considered metadata as it can describe various properties of the document including properties that facilitate the dynamic behavior of respective content elements, which behavior can vary depending upon the properties of the respective content elements.

The attribute assignment component 74 can also provide attribute data to specify the source-related information for content, such as metadata representing a source identifier, a name or other identifying information, a cost of using the content or other properties that may facilitate use and editing of the content by end users. These properties can be added as the attribute data automatically as part of the ingest process or can be added in response to user instructions via the user interface 66.

The content ingest engine 70 can also include a composer 76 providing instructions that can be executed by the processor 64 for populating the source complex document 52 with content element data 80 and associated attribute data 82. The composer 76 can employ a layout engine 78 to arrange the content elements 80 within the content source document 52 according to the attribute data that has been assigned and added to the respective elements (e.g., by the attribute assignment component). For example, the layout engine 78 can employ a set of rules and one or more layout formats that control into which containers each of the content elements 80 is inserted. For example, the layout engine 78 can employ a layout algorithm that may provide a fixed or dynamic layout format for each of a plurality of pages.

By way of example, the composer 76 can generate and store the source complex document 52 as a multi-level hierarchical data structure of elements, group of elements, pages and spreads. A spread is a two-page layout format that can be displayed to a user with an arrangement of user-perceptible representations of content elements. A spread, a page and/or a container on a page can also include a respective layout format. That is, a layout can be nested within another layout.

As a further example, the composer 76 can generate and store each spread of the multi-spread multi-source source complex document 52 as a separate binary tree in which the content elements are provided as leaf nodes of the respective tree representation for the data structure (see, e.g., FIG. 3). The layout engine 78 can apply rules and layout criteria to the attribute data of each content element to determine how to append the tree with the respective content elements. The format of the source complex document can be the same as a target complex document 92 that can be created and generated within the system 50.

In addition to populating the content source document 52 with the content elements 80 and associated attribute data 82, the composer 76 can provide a source complex document with a layout element 84. The composer can generate the layout element 84 to define the structure of the source complex document 52 that controls the appearance thereof. As an example, the layout element 84 can be implemented as a hierarchical graph in which content elements are located at nodes in the graph based upon the attribute data 82.

The processor 64 can store the source complex document 52 in associated memory 86 such that it may be accessible via the processor 64 or via another user device 88. For example, one or more user devices 88 can be coupled to the network 62 and be able to access any number of source complex documents, including the source complex document 52 generated by the system 50. For instance, the source complex document 52 may be stored in the system 50 that provides a complex document tool 90, such as in a cloud computing environment. The document tool 90 can be accessed and utilized by various user devices 88 via the network 62. For example, a user of a user device 88 can employ the document tool 90 to create or edit the target complex document. Since the source complex document 52 is generated to have the same format as the target complex document 92, editing of the target complex document is facilitated within the system 50 via the document tool. For instance, a user can implement native copy and edit functionality of the document tool 90 to add or edit content 94 in the target complex document, without requiring any resort on the part of the user to the original content sources 54 or associated external applications to access the content outside of the services provided by the document tool.

In one example implementation, the complex source document 52 or at least selected content elements thereof can be generated with restrictive properties, as defined by attribute data, to prevent copying or use of the source complex document outside of a cloud environment or without use of the document tool 90 or other pre-authorized document services 96.

As a further example, a user can employ the document services 96 to access content elements from a plurality of source complex documents, which may include one or a plurality of source complex documents 52 generated by the system 50, as well as other source documents that may be user-generated. The set of source complex documents can be presented to the user via respective user interfaces in a single window browser to facilitate copying and manipulation of content elements from the source complex documents into a corresponding target source complex document.

The source complex documents may be implemented with a fixed layout such as defined by the layout element 84 so that the content elements and the attribute data can remain associated with a given source complex document such as to facilitate creation of new target documents and tracking of the original content that is being used.

FIG. 3 illustrates an example of a multi-level hierarchical data structure 100 corresponding to a spread. The data structure 100 can be represented as a binary tree having a plurality of container nodes 102, 104, 106 and 108 and corresponding content nodes. In the example of FIG. 3 the content nodes are implemented as leaf nodes corresponding to the content elements. A given source complex document can be formed of multiple spreads, which may be the same or different depending on the layout format utilized by the composer (e.g. composer and layout engine of FIG. 2).

In the example of FIG. 3, the spread 100 includes a first container node (“Page 1”) and a second container node (“Page 2”), each of which represents a respective page of the spread. Branching from the node 104 are a leaf node (“Heading Text 1”) and another container node (“Body 1”) 108. The container node 108 further includes three child content nodes, demonstrated as a text block (“Text Block 1”) node, an image (“Photo #1”) and a second image photograph (“Photo #2”). The container node 106 includes three child leaf content nodes, demonstrated as a heading (“Heading Text # 2”), a third image photograph (“Photo #3”) and a second text block (“Text Block #2”). The example of FIG. 3 demonstrates but one example of a hierarchical representation for a spread that can be implemented in source complex document or a target complex document. Various other structures and content can be utilized based on the teachings herein.

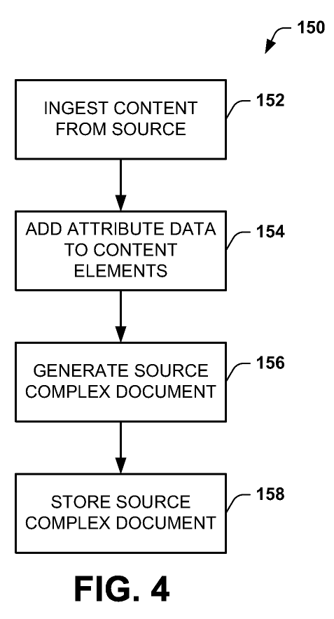

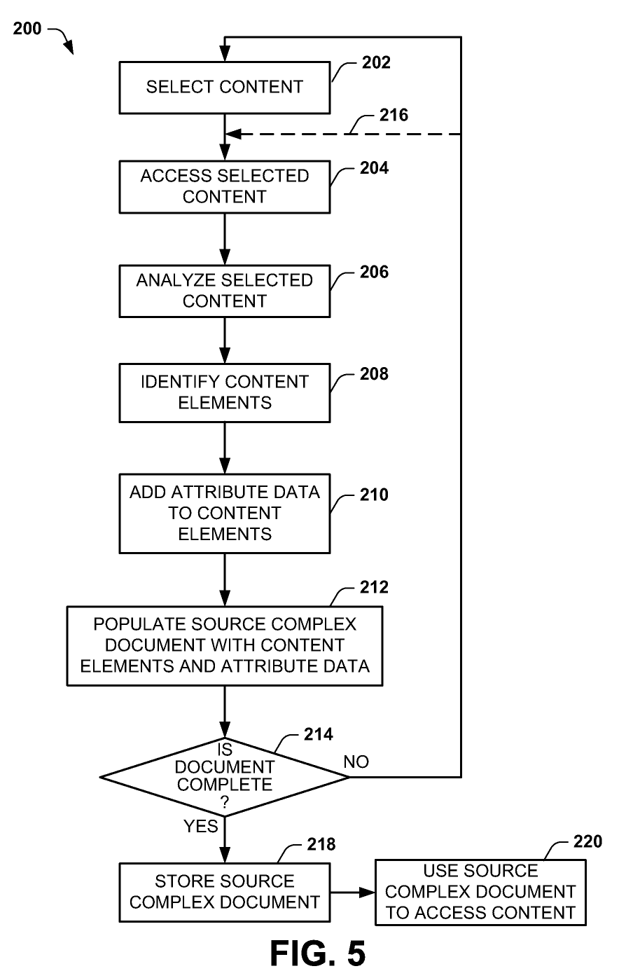

In view of the foregoing structural and functional features described above, an example method will be better appreciated with reference to FIGS. 4 and 5. While, for purposes of simplicity of explanation, the example methods of FIGS. 4 and 5 are shown and described as executing serially, it is to be understood and appreciated that the examples are not limited by the illustrated order, as some actions could in other examples occur in different orders and/or concurrently from that shown and described herein. The methods of FIGS. 4 and 5 can be implemented as computer executable instructions by a processor (e.g., the processor 64 of FIG. 2) or stored in memory as computer readable instructions.

FIG. 4 depicts an example of a method 150 that can be utilized to generate a source complex document. The method begins at 152 in which selected content from a content source is ingested (e.g., by content ingest engine 14 of FIG. 1 or 70 of FIG.2). At 154, attribute data is added to selected content elements. At 156, a source complex document is generated (e.g., source complex document 12 of FIG. 1 or 52 of FIG. 2). The source complex document can be stored in memory (e.g., memory 86 of FIG. 2). For example, the source complex document can be used directly to access the source content in a complex document creation tool.

FIG. 5 depicts an example of another method 200 that can be utilized to generate a source complex document. The method 200 begins at 202 in which content is selected. For instance, the content can be selected via a user interface (e.g., user interface 66 of FIG. 2). At 204, the selected content can be accessed and retrieved. For example, the selected content can be accessed from a content source (e.g., source 20 of FIG. 1 or 54 of FIG. 2) via a corresponding interface (e.g., interface 16 of FIG. 1).

At 206, the selected content can be analyzed (e.g., by the content ingest engine 14 of FIG. 1 or the analyzer 72 of FIG. 2). For example, the content can be analyzed as it is retrieved by parsing properties of the document as well as the content itself. The analysis can be implemented within the system or by employing external analysis functions and methods that may be accessible by the system implementing the method 200.

At 208, content elements from the selected content can be identified. The identification of content elements can be based on the analysis at 204, which as mentioned above can include parsing the selected content and extracting separate content elements therefrom. At 210, attribute data is added to the content elements. For example, the attribute data can be added (e.g., by an attribute assignment component 74 of FIG. 2) to specify layout properties that may vary based upon the document properties determined from the analysis at 206. The attribute data can also include other content characteristics or source-related information.

At 212, a source complex document is populated with content elements and attribute data (e.g., by a composer 76 of FIG. 2) according to a layout procedure. For instance, a composer can employ a layout engine that applies rules and layout criteria to populate the source complex document with the content elements based upon the attribute data that has been added at 210.

At 214 a determination is made as whether the source complex document is complete. If the document is not complete, (e.g., indicating that additional content is to be added), the method can return to 202 to select additional content. Alternatively, as indicated by the dashed line 216, the method may proceed from 214 to access the content at 204, such as in a situation when the content had been selected previously. That is, the method 200 can be implemented in an offline manner from 204 onward such as in response to selecting content, a priori, that is to be added in a separate document generation phase in response to user instructions, such as described herein. If the determination at 214 indicates that the document is complete, the method can proceed to 218 in which the source complex document can be stored in a storage media (e.g., memory 86 of FIG. 2.).

At 220, the source complex document can be used directly to access the source content in a complex document creation tool (e.g., the tool 11 of FIG. 1 or 90 of FIG. 2). As an example, the source complex document provides an intermediate interface to content obtained from one or more sources of content. This source complex document is provided in the same format such that a target complex document can be created and edited with content from the source complex document using a common set of interface functionality provided within the complex document creation tool. For example, a user can implement native copy and edit functionality of the tool, such as to add or edit content in the target complex document, without requiring any resort on the part of the user to the original content sources or associated external applications to access the content outside of the services implementing the method 200.

What have been described above are examples. It is, of course, not possible to describe every conceivable example of the invention, but one of ordinary skill in the art will recognize that other example embodiments are possible. Accordingly, this disclosure is intended to embrace all embodiments, such as including alterations, modifications, and variations that fall within the scope of the appended claims.

What is claimed is:

1. A system to generate a source complex document comprising:
memory for storing computer executable instructions; and
a processing unit for accessing the memory and executing the computer executable instructions, the computer executable instructions comprising:
an interface to access selected content from a source of content; and
an ingest engine to populate the source complex document with the selected content from the source of content, attribute data being added to the selected content and stored with the selected content in the memory such that the selected content of the source complex document is dynamically linked via the attribute data in a format that is substantially identical to that of a target complex document.

2. The system of claim 1, wherein the ingest engine further comprises:
an analyzer to analyze properties of the selected content; and
an attribute assignment component to assign the attribute data to content elements derived from the selected content based on the properties of the selected content.

3. The system of claim 2, wherein the attribute data is assigned to the content elements to maintain document properties of a user-perceptible representation of the selected content.

4. The system of claim 2, wherein the source complex document comprises a plurality of pages, each of the plurality of pages comprising the content elements and the attribute data, corresponding to the selected content, the computer executable instructions of the system further comprising:
a composer to employ a layout engine to arrange the content elements on the plurality of pages according to an automated layout procedure based on the attribute data.

5. The system of claim 4, wherein the content elements and attribute data of the source complex document comprises a hierarchical arrangement of document content, at least a portion of the attribute data being used to establish the hierarchical arrangement of the content elements for each of the plurality of pages of the source complex document.

6. The system of claim 1, wherein the source complex document comprises a source magazine of the selected content, the content elements and associated attribute data derived from the selected content for each page of the source magazine being stored in the memory as a hierarchical data structure.

7. The system of claim 1, wherein the source complex document comprises a plurality of source complex documents, each containing a plurality of content elements and associated attribute data.

8. The system of claim 1, wherein the computer executable instructions further comprise a complex document tool to access content contained within the source complex document for creation or editing of the target complex document without user reference to the original source of content.

9. A system for generating a source complex document comprising:
an ingest engine employed by a processor to populate the source complex document with content elements and associated attribute data derived from content selected from a source of content via an interface, the ingest engine comprising:
an analyzer to analyze the selected content and determine properties a type for each of the content elements;
an attribute assignment component to assign the associated attribute data to the respective content elements based on the properties determined for the content elements to facilitate copying and manipulation of the selected content from the source complex document;
a composer to employ a layout engine to arrange the content elements in the source complex document in a format that is commensurate with that of a target complex document according to dynamic layout criteria applied to the associated attribute data; and
a complex document tool to access content contained within the source complex for creation or editing of the target complex document without user reference to the original source of content.

10. The system of claim 9, wherein the source complex document is stored in memory according to a tree data structure representation that defines the layout and hierarchy of the content elements for the source complex document.

11. The system of claim 10, wherein the source complex document comprises a plurality of pages, each of the plurality of pages comprising at least a portion of a corresponding tree data structure representation.

12. The system of claim 11, wherein the source complex document comprises a source magazine of the selected content, the content elements and the associated attribute data for each page of the source magazine being stored in the memory as a hierarchical tree data structure representation.

13. A method of generating a source complex document comprising:
ingesting, at a processor, selected content received from a content source via an interface and identifying content elements from the selected content;
adding attribute data to each of the content elements according to properties thereof the respective content elements;
populating, by a processor, the source complex document with the content elements, the content elements being dynamically arranged within the source complex document according to a layout procedure based on the attribute data as to preserve a respective dynamic behavior of each of the content elements in the source complex document; and
storing the source complex document in memory in a format that is commensurate with that of a target complex document.

14. The method of claim 13, wherein the selection of at least a portion of the selected content occurs prior to the populating such that the populating of the source complex document with the at least a portion of the selected content is performed as an automated process based on the selection.

15. The method of claim 13, wherein the source complex document comprises a source magazine, the content elements and associated attribute data for each of a plurality of pages of the source magazine being stored in the memory as a hierarchical data structure representation.
